(19) United States
(12) Patent Application Publication
(10) Pub. No.: US 2015/0203202 A1
(43) Pub. Date: Jul. 23, 2015

(54) RAPID ENVIRONMENTAL CONTROL AERIAL DELIVERY SYSTEM

(71) Applicant: Capewell Systems, LLC, South Windsor, CT (US)

(72) Inventor: Stephen T. Parkinson, Suffield, CT (US)

(73) Assignee: Capewell Components Company, LLC, South Windsor, CT (US)

(21) Appl. No.: 14/162,166

(22) Filed: Jan. 23, 2014

(51) Int. Cl. B64D 1/16; A62C 3/02; B64D 1/12; B64D 1/10

(52) U.S. Cl. CPC B64D 1/16; B64D 1/10; A62C 3/0235; A62C 3/025; B64D 1/12

(57) ABSTRACT

An aerial delivery system for use with aircraft having a rear ramp and a cargo handling system. The aerial delivery system includes a cartridge base platform and a ramp platform. The cartridge base platform locks to the aircraft cargo handling system and the ramp platform locks to the aircraft ramp. A restraint subsystem restrains one or more cargo containers positioned on the cartridge base platform.

### BACKGROUND

This disclosure relates generally to devices, systems and methods for selectively delivering water, other liquids, other solids and/or other materials to a target location. More particularly, this disclosure relates to devices, systems and methods for selectively delivering fire suppressant from airborne vehicles.

Conventionally, to fight wild fires, aircraft are used to deploy water and fire retardant chemicals at or around the wild fire to contain the wild fire or put out the wild fire. To this end, the aircraft flies very close to the ground location or target location to ensure that the water and fire retardant chemicals dispersed in the air reach the target location. If the aircraft is too high above the target location, then the dispersed water and/or fire retardant chemicals may be blown over a large area so that its concentration may be ineffective at containing the fire or putting out the fire. Accordingly, there is a need in the art for devices, systems and methods for selectively delivering water and fire retardant chemicals a target location.

U.S. Pat. No. 8,480,035 discloses a system to disperse fire suppressant directly from containers, delivered by military transport aircraft. Although the system disclosed in the '035 patent is an improvement over other conventional systems, substantial effort is required to rig and check the payload in the aircraft prior to take off resulting in considerable down time in an operational day, which limits the number of sorties the aircraft can make.

Another conventional system disperses fire suppressant chemical directly from an aircraft which can be pumped directly on to the aircraft to minimize turn round time. However, this system suffers from the time delay required to convert the aircraft to the new role and the cleaning operation required to remove fire suppressant chemical from the exterior of the aircraft is intense.

The subject system reduces the turn round time for rigging gravity extracted payload. The system utilizes a cartridge to preload the containers and the expended cartridge remains after gravity extraction. Ground operations are limited to extraction of the empty cartridge and replenishment with a full cartridge, potentially doubling the number of air drops that may be conducted in a day, without specialized role fit, both of which have benefit in time and resource critical operations such as forest fire suppression.

### SUMMARY

An aerial delivery system for use with aircraft having a rear ramp and a cargo handling system. The aerial delivery system includes a cartridge base platform and a ramp platform. The cartridge base platform locks to the aircraft cargo handling system and the ramp platform locks to the aircraft ramp. A restraint subsystem restrains one or more cargo containers positioned on the cartridge base platform.

The cartridge base platform includes a delivery platform having interface elements to interact with the aircraft's cargo handling system.

The cartridge base platform also includes at least one conveyor extending longitudinally along a top surface of the delivery platform and multiple side guidance elements extending from the delivery platform top surface adjacent to the conveyor.

The conveyor comprises at least one set of roller conveyors, which may be removable and/or configurable for different payloads.

The cartridge base platform also includes attachments for restraint straps.

The conveyor may convey a single column of cargo containers and include first and second sets of roller conveyors, with the second set of roller conveyors being adjacent and parallel to the first set of roller conveyors.

The guidance elements for single conveyor may include first and second rows of rotating bollards that are adjacent to outer edges of the conveyor.

The cartridge base platform may include first and second conveyors that convey two columns of cargo containers, with the second conveyor being adjacent and parallel to the first conveyor. Each conveyor includes at least one set of roller conveyors.

The guidance elements for the twin conveyors may include first, second, third and fourth rows of rotating bollards. The first row of bollards are adjacent to an outer edge of the first conveyor, the second row of bollards are adjacent to an inner edge of the first conveyor, the third row of bollards are adjacent to an inner edge of the second conveyor and the fourth row of bollards are adjacent to an outer edge of the second conveyor.

The side guidance elements may comprise rails having a low friction surface disposed adjacent the conveyor.

The ramp platform includes a delivery platform may have interface elements that interact with the ramp's cargo handling system.

The ramp platform may also include at least one conveyor extending longitudinally along a top surface of the delivery platform and multiple side guidance elements extending from the delivery platform top surface adjacent to the conveyor.

The restraint subsystem includes multiple webbing straps, multiple clevises, multiple tensioning devices and multiple release mechanisms.

The release mechanisms may be wireless gate releases.

### BRIEF DESCRIPTION OF THE DRAWINGS

The present disclosure may be better understood and its numerous objects and advantages will become apparent to those skilled in the art by reference to the accompanying drawings in which:

FIG. 1 is a fragmentary perspective view of a transport aircraft having a conventional cargo handling system and an empty cargo hold;

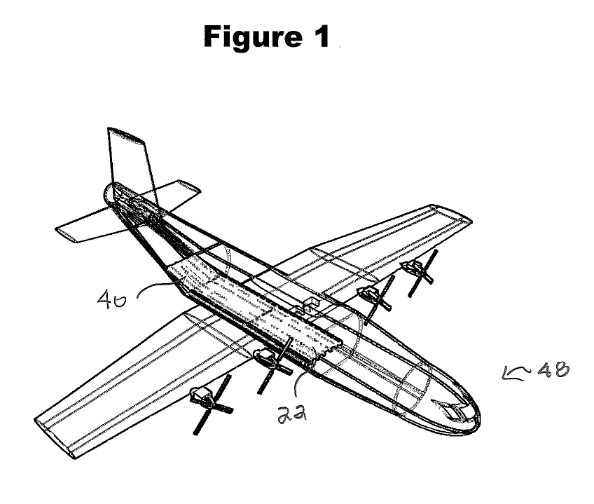

FIG. 2 is an enlarged fragmentary perspective view of the cargo handling system of FIG. 1;

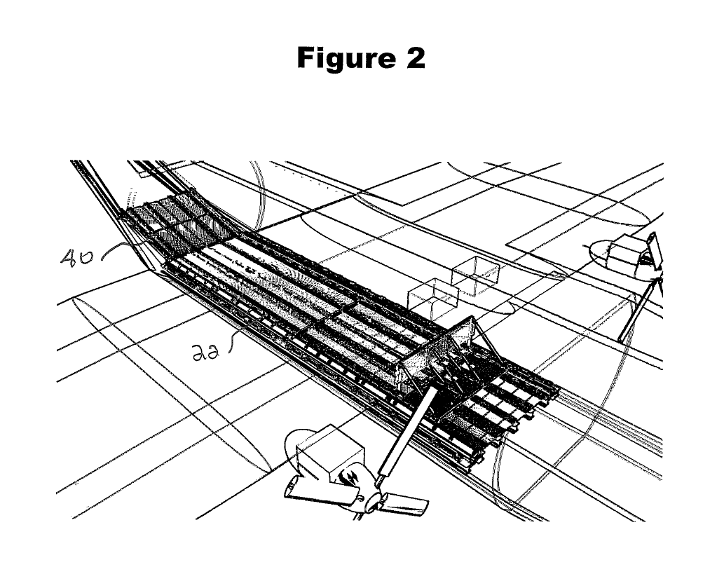

FIG. 3 is a perspective view of an aerial delivery system in accordance with the subject description;

FIG. 4 is an enlarged perspective view of a first embodiment of the cartridge of FIG. 3;

FIG. 5 is an enlarged perspective view of the cartridge, containers and container retention device of FIG. 3;

FIG. 6 is a fragmentary perspective view illustrating the aircraft being loaded with the aerial delivery system;

FIG. 7A is a fragmentary perspective view illustrating the aircraft being loaded with the ramp element;

FIG. 7B is an enlarged view of the ramp element of FIG. 7A;

FIG. 8 is a fragmentary perspective view illustrating the aircraft ramp being raised;

FIG. 9A is a fragmentary side view showing the aircraft with a load of containers and the ramp in the raised position;

FIG. 9B is a fragmentary side view showing the aircraft with a load of containers and the ramp in the lowered position;

FIG. 9C is a fragmentary side view showing the aircraft with a load of containers and the vertical and lateral restraints released;

FIG. 10A is a fragmentary perspective view showing the aircraft ready to drop the containers;

FIG. 10B is a fragmentary perspective view showing the aircraft after dropping a number of the containers; and

FIG. 11 is a fragmentary side view showing the aircraft after dropping the containers with the ramp in the raised position.

### DETAILED DESCRIPTION

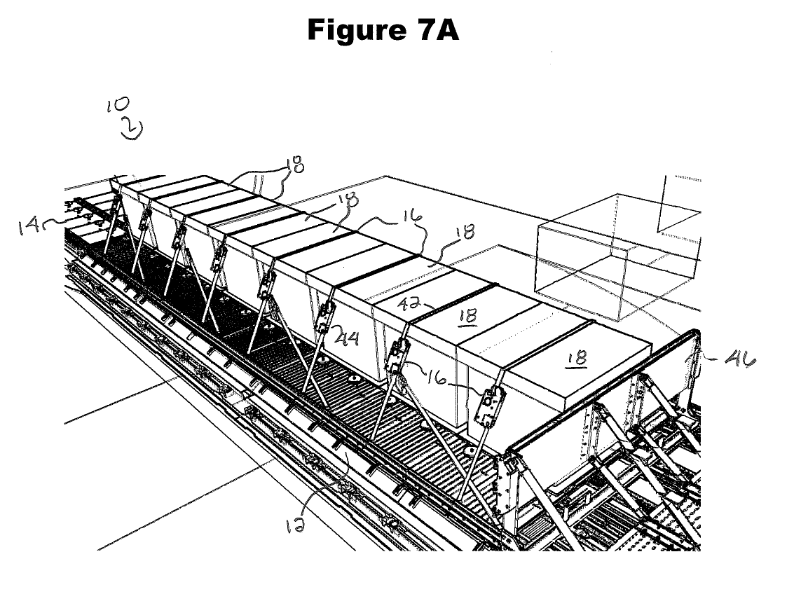

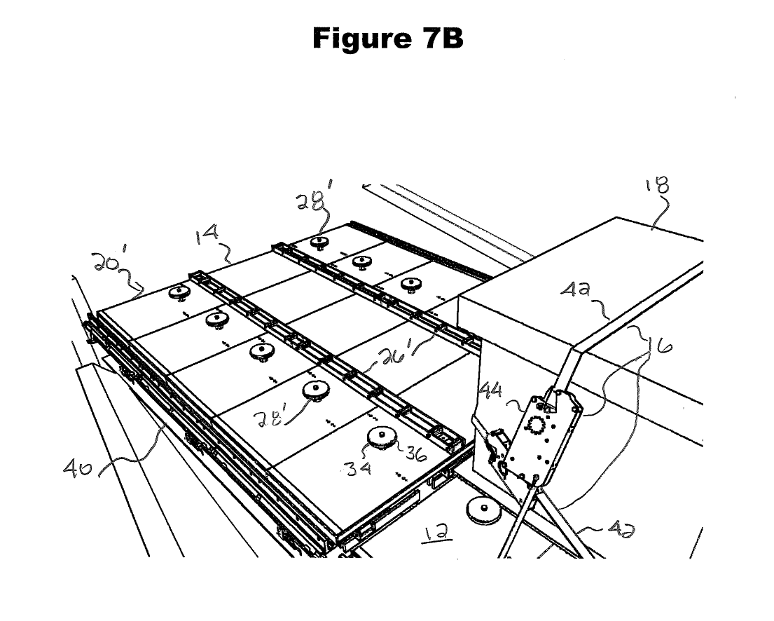

With reference to the drawings wherein like numerals represent like parts throughout the several figures, an aerial delivery system in accordance with the present disclosure is generally designated by the numeral 10. With reference to FIGS. 7A and 7B, the aerial delivery system or cartridge 10 comprises a cartridge base platform 12, a ramp platform 14 and a restraint subsystem 16. The aerial delivery system 10 is intended for use with aerial delivery cargo containers 18 of the type shown in U.S. Pat. No. 8,480,035, although it may be used with other aerial delivery containers, aerial delivery systems and air cargo systems as explained below.

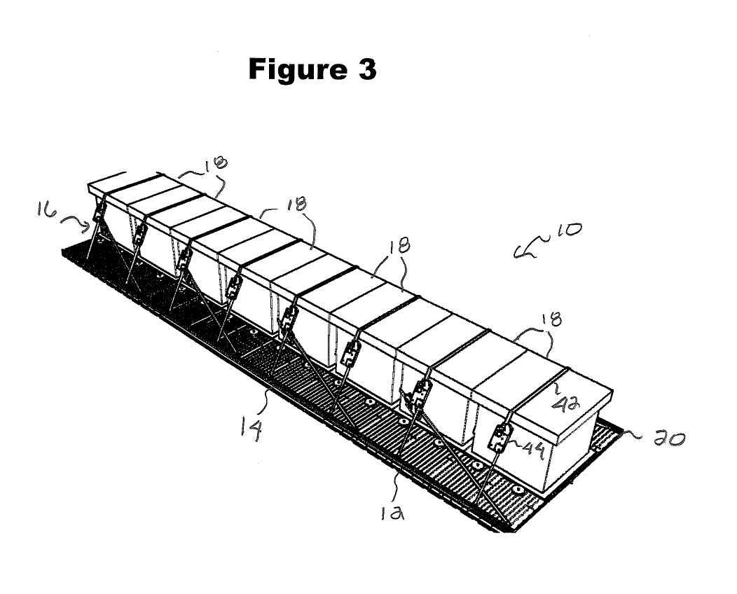

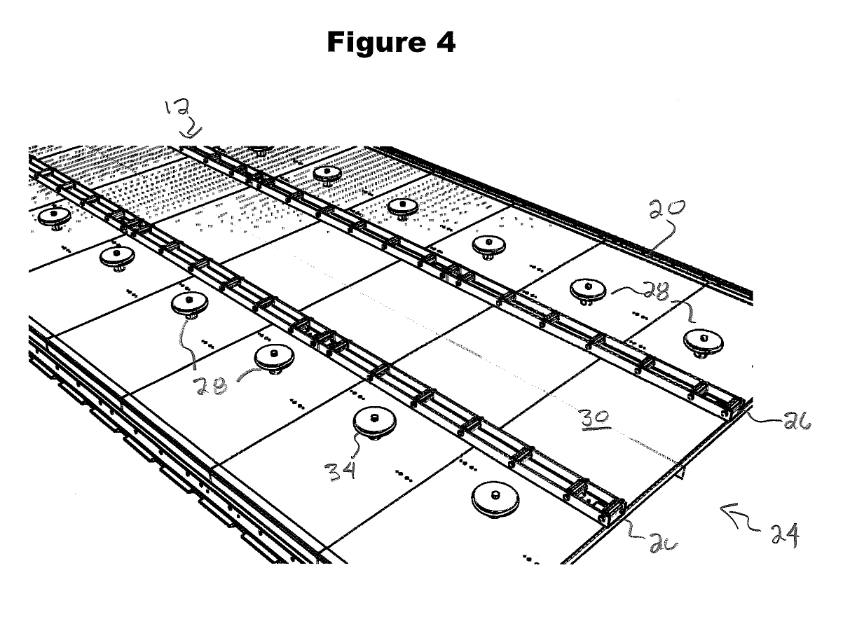

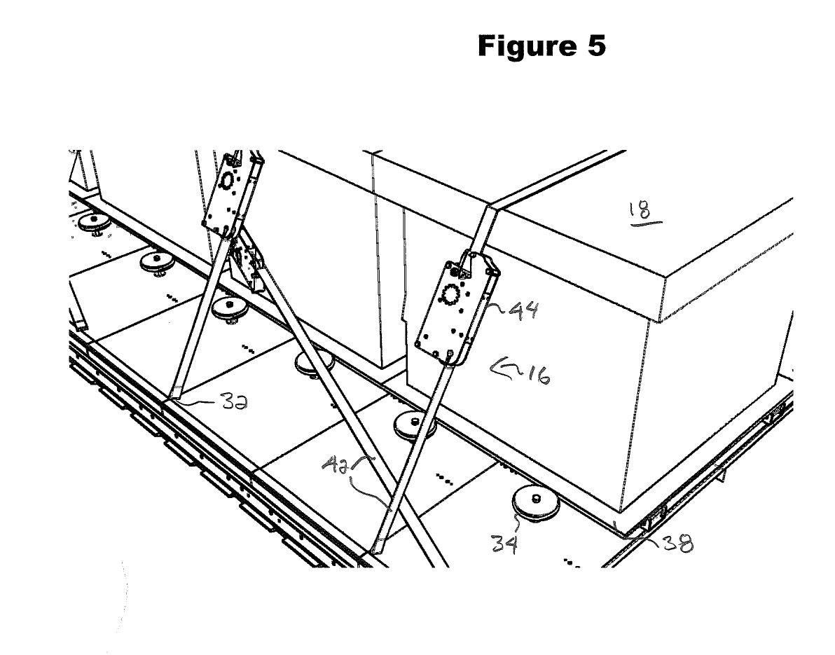

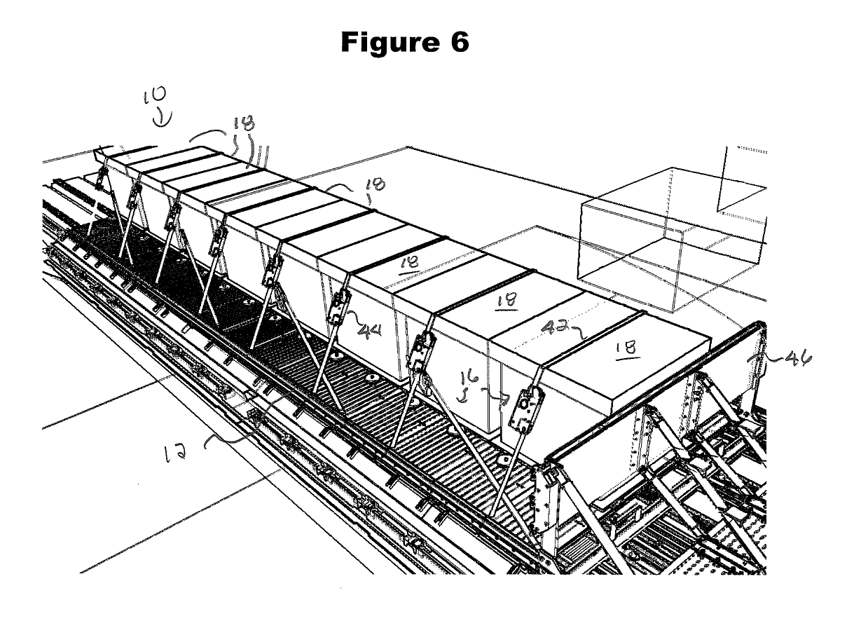

The cartridge base platform 12 includes an aerial delivery platform 20 having conventional interface elements (not shown), allowing the platform 20 to interact with the aircraft's cargo handling system 22. In the example shown in FIG. 3, the cartridge base platform 12 has a 32 ft aerial delivery platform 20. With additional reference to FIG. 4, the cartridge base platform 12 also includes a conveyor 24 having a series of roller tracks 26 and side guidance features 28 on the top surface 30. The roller conveyors 26 are removable, and can be configured for different payloads. Attachment provisions 32 for restraint straps are also included, FIGS. 5 and 6.

The embodiment shown in FIGS. 3-8 includes two central roller tracks 26 and rotating bollards 34 forming two rows of side guidance features 28 spaced to support a single column of 48″ wide containers 18 centered on the platform 20. Another embodiment includes four rows spaced to support two columns of 48″ wide containers symmetrically loaded on the platform. Side guidance features 28 includes vertical bollards 34 with an integral rolling element 36 which contacts the base board 38 of the container 18. Side guidance bollards 34 can also be reconfigured for one or two columns of 48″ wide payloads. Another embodiment of the side guidance feature 28 includes rails extending the length of the platform which have a low friction surface in place of any moving mechanical elements. The low friction surface could comprise nylon or UHMW polyethylene, for example.

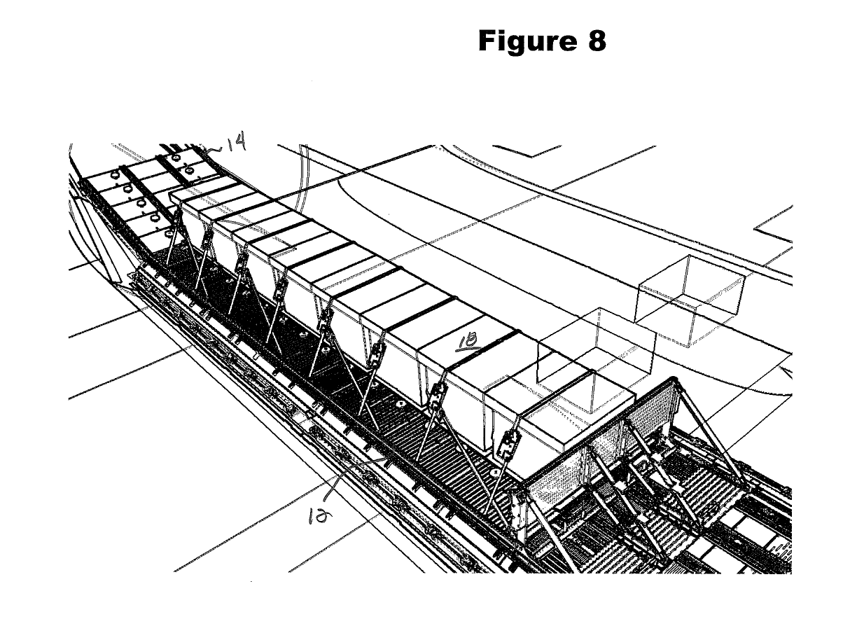

The ramp platform 14, FIGS. 7A, 7B and 8, also includes an aerial delivery platform 20′ with conventional elements for interfacing with the aircraft cargo handling system 22. The ramp platform 14 is sized to fit on the aircraft cargo ramp 40. The top of the ramp platform 14 is also fitted with roller tracks 26′ and side guidance features 28′ to match the cartridge base platform 12. Restraint features are not necessary.

The restraint subsystem 16, FIGS. 3, and 5-10, includes a series of webbing straps 42 with clevises, tensioning devices, and release mechanisms 44 which attach the containers 18 to the cartridge base platform 12 during handling and flight, yet can be rapidly released to allow airdrop. Straps must provide upward, aft and lateral restraint to meet standard air transportability requirements. Forward restraint is provided by a forward bulkhead 46. This can be either a standard buffer stop assembly typically used in container delivery system (CDS) airdrops which is separately installed, or an alternate bulkhead structure incorporated in the base cartridge platform 12

The restraint subsystem 16 may include wireless gate releases (WGRs) to allow release of straps via remote command. Another embodiment makes use of conventional CDS airdrop techniques, using guillotine knifes attached to the static line retrieval winch. Straps may need separate provisions such as elastic bungee cords to move the released straps out of the way of moving payloads to prevent fouls.

Typically in operation, fire suppressant containers 18 are loaded onto the cartridge 10, for example the eight Caylym Guardian™ fire suppressant containers shown in FIG. 3, and attached thereto by the restraint subsystem 16 (see FIG. 5). The system 10 requires dunnage between adjacent containers 18, in order to successfully transmit forward aircraft acceleration forces to the forward restraint 46.

The rigged cartridge 10 is then loaded onto the aircraft 48 using conventional ground handling equipment, FIG. 6. The cartridge 10 has sufficient mechanical strength for a rigged cartridge 10 to be lifted by overhead crane onto a K loader or similar ground handling equipment. If the aircraft's cargo handling system 22 includes a buffer stop assembly (BSA) rather than an integral forward barrier, a temporary forward restraint must be applied in order to rig the cartridge 10. The cartridge 10 is then locked into the aircraft cargo handling system (CHS) 22. It is probable that the dunnage between the cartridge 10 and the restraint 46 will require adjustment in order to ensure a good load path; otherwise no further rigging activity is required. This is where significant time saving is achieved. Conventional gravity extraction systems require extensive rigging, and inspection, in the aircraft.

In order to provide roller continuity across the ramp 40, the system 10 also requires a ramp platform 14 to be loaded and locked to the cargo handling system 22 on the aircraft ramp 40, FIGS. 7A and 7B. After the aircraft ramp 40 is raised, FIG. 8, the aircraft is ready for departure.

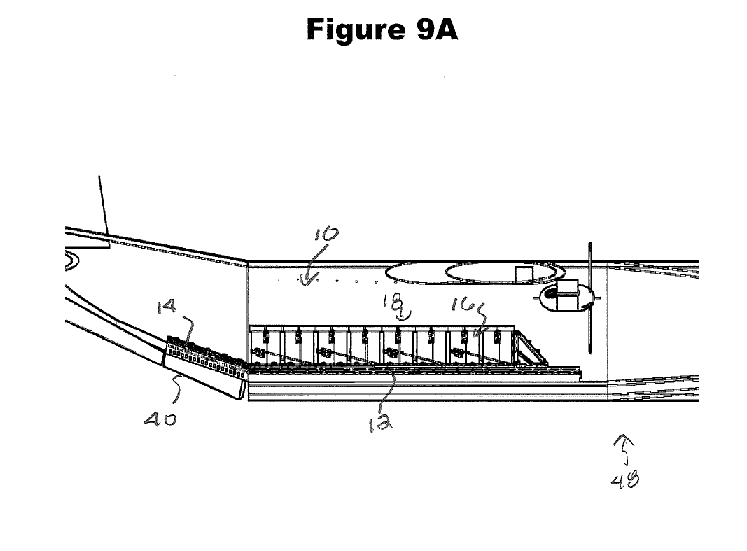

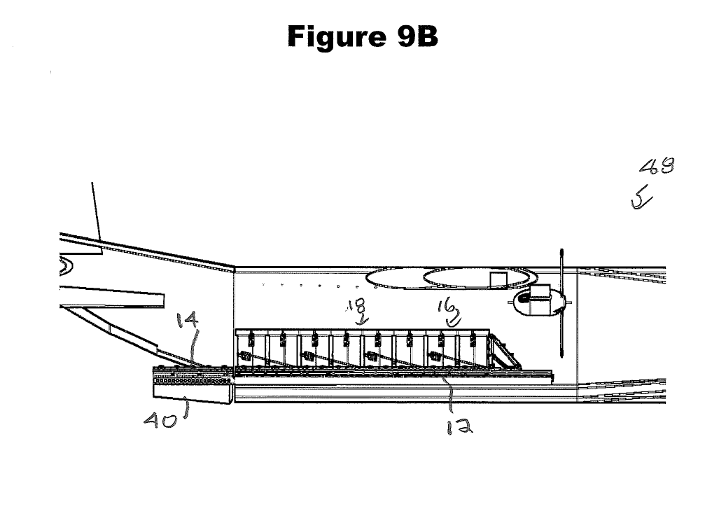

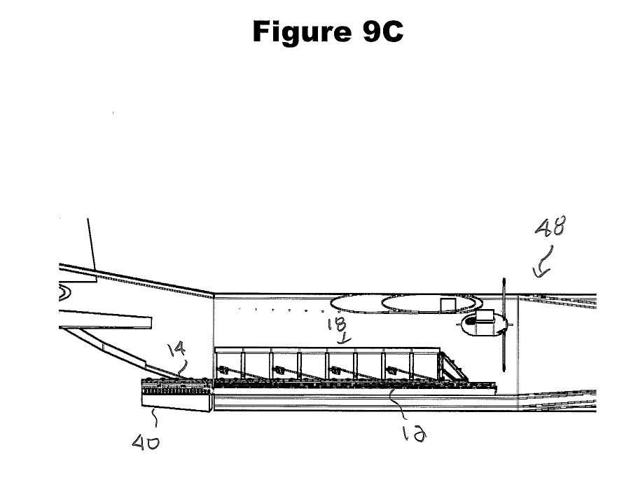

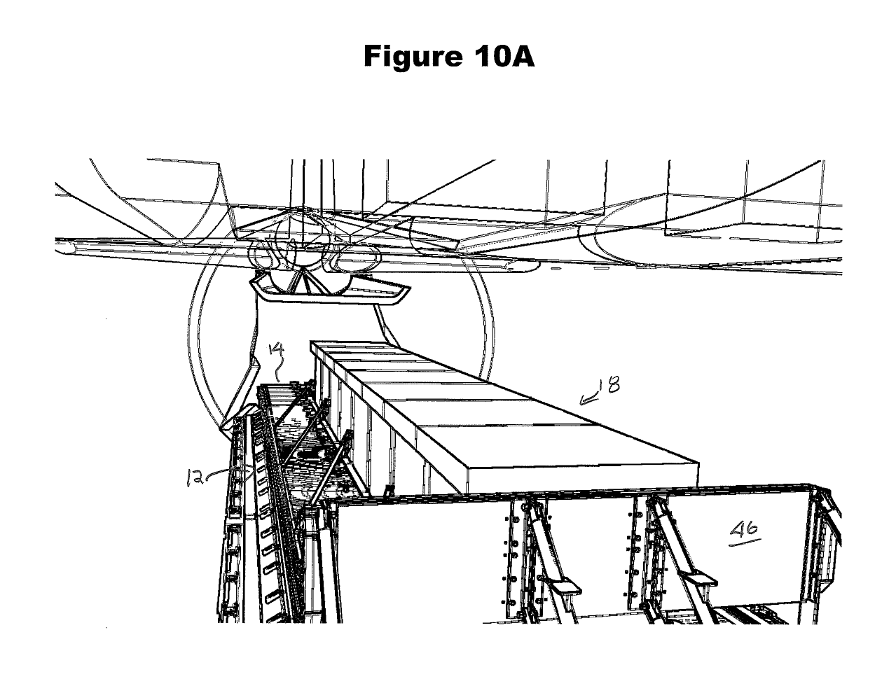

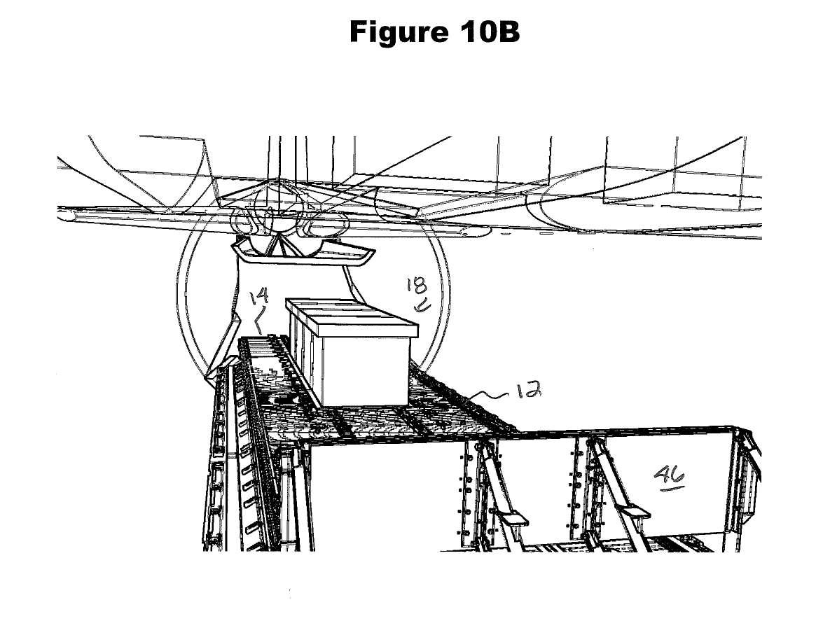

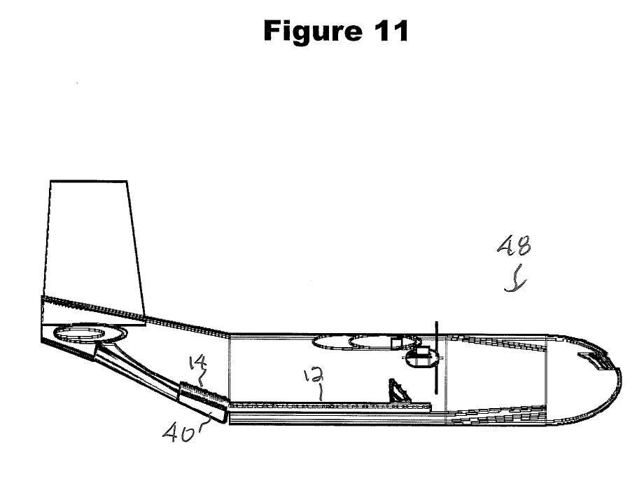

Upon arrival at the drop zone (FIG. 9A), the ramp 40 is lowered (FIG. 9B) and the vertical and lateral restraints of the restraint subsystem 16 are removed/retracted (FIG. 9C), placing the system 10 in a pre-drop condition (FIG. 10A). When the order is given to drop the containers 18, any remaining components of the restraint subsystem 16 removed/retracted and the containers 18 are conveyed out of the aircraft 48 (FIG. 10B). After completion of the drop, the aircraft ramp 40 is raised and the aircraft 48 returns to the base (FIG. 11).

Conventional container delivery system airdrop requires restraint straps be applied after the cargo is loaded into the aircraft. This is followed by an extensive inspection. Both these operations are time consuming and must be completed before the aircraft can depart on the next sortie. The subject system 10 allows the rigging and inspection to be conducted ahead of time before the aircraft arrives, reducing the amount of time the aircraft spends on the ground between missions.

It will be appreciated that various of the above-disclosed and other features and functions, or alternatives thereof, may be desirably combined into many other different systems or applications. Any bulk cargo airdrop where rapid turn around is required could be addressed. For example, distributing enzyme to control ‘Red tide’, deploying survival equipment or shark repellant dye to aid search and rescue efforts in a maritime disaster, or distributing herbicide on illegal crops could be addressed. Also that various presently unforeseen or unanticipated alternatives, modifications, variations or improvements therein may be subsequently made by those skilled in the art which are also intended to be encompassed by the following claims.

What is claimed is:

1. An aerial delivery system for use with aircraft having a rear ramp and a cargo handling system, the aerial delivery system comprising:
a cartridge base platform adapted to lock to the aircraft cargo handling system;
a ramp platform adapted to lock to the aircraft ramp; and
a restraint subsystem adapted to restrain one or more cargo containers disposed on the cartridge base platform.

2. The aerial delivery system of claim 1, wherein the cartridge base platform includes a delivery platform having interface elements adapted to interact with the aircraft's cargo handling system.

3. The aerial delivery system of claim 2, wherein the cartridge base platform also includes:
at least one conveyor extending longitudinally along a top surface of the delivery platform; and
a plurality of side guidance elements extending from the delivery platform top surface adjacent to the conveyor.

4. The aerial delivery system of claim 3, wherein the conveyor comprises at least one set of roller conveyors.

5. The aerial delivery system of claim 4, wherein the roller conveyors are removable.

6. The aerial delivery system of claim 4, wherein the roller conveyors are configurable for different payloads.

7. The aerial delivery system of claim 3, wherein the cartridge base platform also includes attachments for restraint straps.

8. The aerial delivery system of claim 4, wherein the conveyor is adapted to convey a single column of cargo containers and includes first and second sets of roller conveyors, the second set of roller conveyors being adjacent and parallel to the first set of roller conveyors.

9. The aerial delivery system of claim 8, wherein the guidance elements include first and second rows of rotating bollards, the first row of bollards being adjacent to an outer edge of the conveyor and the second row of bollards being adjacent to another outer edge of the conveyor.

10. The aerial delivery system of claim 3, wherein the cartridge base platform includes first and second conveyors adapted to convey two columns of cargo containers, the second conveyor being adjacent and parallel to the first conveyor, each conveyor including at least one set of roller conveyors.

11. The aerial delivery system of claim 10, wherein the guidance elements include first, second, third and fourth rows of rotating bollards, the first row of bollards being adjacent to an outer edge of the first conveyor, the second row of bollards being adjacent to an inner edge of the first conveyor, the third row of bollards being adjacent to an inner edge of the second conveyor and the fourth row of bollards being adjacent to an outer edge of the second conveyor.

12. The aerial delivery system of claim 3, wherein the side guidance elements comprise rails having a low friction surface disposed adjacent the conveyor.

13. The aerial delivery system of claim 1, wherein the ramp platform includes a delivery platform having interface elements adapted to interact with the ramp's cargo handling system.

14. The aerial delivery system of claim 13, wherein the ramp platform also includes:
at least one conveyor extending longitudinally along a top surface of the delivery platform; and
a plurality of side guidance elements extending from the delivery platform top surface adjacent to the conveyor.

15. The aerial delivery system of claim 1, wherein the restraint subsystem includes:
a plurality of webbing straps;
a plurality of clevises;
a plurality of tensioning devices; and
a plurality of release mechanisms.

16. The aerial delivery system of claim 15 wherein the release mechanisms are wireless gate releases.

17. An aerial delivery system for use with aircraft having a rear ramp and a cargo handling system, the aerial delivery system comprising:
a cartridge base platform including a base delivery platform having interface elements adapted to interact with the aircraft's cargo handling system to lock the cartridge base platform to the aircraft cargo handling system;
a ramp platform including a ramp delivery platform having interface elements adapted to interact with the ramp's cargo handling system to lock the ramp delivery platform to the aircraft ramp; and
a restraint subsystem adapted to restrain one or more cargo containers disposed on the cartridge base platform.

18. The aerial delivery system of claim 17, wherein the cartridge base platform also includes:
at least one conveyor extending longitudinally along a top surface of the delivery platform, the conveyor having oppositely disposed side edges; and
a plurality of side guidance elements a one of the side guidance elements extending longitudinally adjacent to one of the conveyor side edges and another of the side guidance elements extending longitudinally adjacent to another of the conveyor side edges.

19. The aerial delivery system of claim 18, wherein the conveyor is adapted to convey a single column of cargo containers and includes at least one set of roller conveyors.

20. The aerial delivery system of claim 19 wherein the conveyor comprises first and second sets of roller conveyors, the second set of roller conveyors being adjacent and parallel to the first set of roller conveyors.

21. The aerial delivery system of claim 18, wherein the cartridge base platform includes first and second conveyors adapted to convey two columns of cargo containers, the second conveyor being adjacent and parallel to the first conveyor, each conveyor including at least one set of roller conveyors.

22. The aerial delivery system of claim 21 wherein each conveyor comprises first and second sets of roller conveyors, the second set of roller conveyors being adjacent and parallel to the first set of roller conveyors.

23. The aerial delivery system of claim 18, wherein each of the side guidance elements comprises a row of rotating bollards.

24. The aerial delivery system of claim 18, wherein each of the side guidance elements comprise rails having a low friction surface disposed adjacent the conveyor.

25. The aerial delivery system of claim 17, wherein the ramp platform also includes:
at least one conveyor extending longitudinally along a top surface of the delivery platform; and
a plurality of side guidance elements a one of the side guidance elements extending longitudinally adjacent to one of the conveyor side edges and another of the side guidance elements extending longitudinally adjacent to another of the conveyor side edges.

26. The aerial delivery system of claim 17, wherein the restraint subsystem includes:
a plurality of webbing straps;
a plurality of clevises;
a plurality of tensioning devices; and
a plurality of release mechanisms.

27. The aerial delivery system of claim 26 wherein the release mechanisms are wireless gate releases.

28. An aerial delivery system for use with aircraft having a rear ramp and a cargo handling system, the aerial delivery system comprising:
a cartridge base platform including a base delivery platform including
interface elements adapted to interact with the aircraft's cargo handling system to lock the cartridge base platform to the aircraft cargo handling system,
at least one conveyor extending longitudinally along a top surface of the delivery platform, the conveyor having oppositely disposed side edges, and
a plurality of side guidance elements a one of the side guidance elements extending longitudinally adjacent to one of the conveyor side edges and another of the side guidance elements extending longitudinally adjacent to another of the conveyor side edges;
a ramp platform including a ramp delivery platform including
interface elements adapted to interact with the ramp's cargo handling system to lock the ramp delivery platform to the aircraft ramp,
at least one conveyor extending longitudinally along a top surface of the delivery platform, and
a plurality of side guidance elements a one of the side guidance elements extending longitudinally adjacent to one of the conveyor side edges and another of the side guidance elements extending longitudinally adjacent to another of the conveyor side edges; and
a restraint subsystem. adapted to restrain one or more cargo containers disposed on the cartridge base platform.
